(19) United States
(12) Patent Application Publication
(10) Pub. No.: US 2020/0254981 A1
(43) Pub. Date: Aug. 13, 2020

(54) VEHICLE

(71) Applicant: TOYOTA JIDOSHA KABUSHIKI KAISHA, Toyota-shi (JP)

(72) Inventors: Satoshi Takeguchi, Toyota-shi (JP); Kunihiko Toyofuku, Toyota-shi (JP)

(73) Assignee: TOYOTA JIDOSHA KABUSHIKI KAISHA, Toyota-shi (JP)

(21) Appl. No.: 16/734,027

(22) Filed: Jan. 3, 2020

(30) Foreign Application Priority Data
Feb. 12, 2019 (JP) 2019-022291

(51) Int. Cl. B60S 1/60; B60R 16/08; B60S 1/50

(52) U.S. Cl. CPC B60S 1/603; B60S 1/50; B60R 16/08

(57) ABSTRACT

A vehicle includes a tank configured to store washing liquid, a washing device configured to wash a first washing target portion and a second washing target portion, and a control device configured to perform manual washing in which the washing device is caused to wash at least the first washing target portion when a washing request is made by an occupant of the vehicle, determine whether the second washing target portion is dirty or not, and perform automatic washing in which the washing device is caused to wash at least the second washing target portion when a determination is made that the second washing target portion is dirty. The control device is configured not to perform the automatic washing even when a determination is made that the second washing target portion is dirty in a case where a stored amount is equal to or smaller than a predetermined threshold amount.

### INCORPORATION BY REFERENCE

The disclosure of Japanese Patent Application No. 2019-022291 filed on Feb. 12, 2019 including the specification, drawings and abstract is incorporated herein by reference in its entirety.

### BACKGROUND

### 1. Technical Field

The disclosure relates to a vehicle that is provided with a washing device configured to be able to wash a first washing target portion and a second washing target portion by means of washing liquid stored in a tank.

### 2. Description of Related Art

In the related art, there is a known vehicle in which windows (for example, front window or rear window) of the vehicle and a window portion of a sensor (for example, camera, radar, lidar or the like) are washed by means of washing liquid stored in a tank. In one of such vehicles (hereinafter, will be referred to as “vehicle in related art”), washing (hereinafter, will be referred to as “manual washing”) is performed with washing liquid ejected toward a window of a vehicle in a case where an occupant (for example, driver) of the vehicle operates a predetermined switch. Furthermore, in a case where a determination is made that a window portion is dirty based on information acquired by a sensor in the vehicle in the related art, washing (hereinafter, will be referred to as “automatic washing”) is performed with washing liquid ejected toward the window portion (for example, refer to Japanese Unexamined Patent Application Publication No. 2016-179767 (JP 2016-179767 A)).

### SUMMARY

The vehicle in the related art automatically determines whether a window portion is dirty or not and in a case where the vehicle in the related art determines that a window portion is dirty, the vehicle in the related art performs the automatic washing even in a case where the switch is not operated by a driver (occupant of vehicle). Therefore, in many cases, the driver does not notice that the amount of remaining washing liquid stored in the tank (stored amount) has become small due to the automatic washing. Accordingly, a situation where the manual washing is not performed since the amount of washing liquid remaining in the tank is insufficient although the driver has operated the switch to perform the manual washing is likely to occur. Therefore, the driver may feel a sense of incompatibility.

The disclosure has been made to cope with the above problem. That is, the disclosure provides a vehicle in which automatic washing and manual washing can be performed, the manual washing can necessarily be performed in a case where the amount of stored washing liquid is small, and an occupant of the vehicle (for example, driver) can recognize that the amount of remaining washing liquid will become small soon.

An aspect of the disclosure relates to a vehicle (hereinafter, will be referred to as “vehicle according to aspect of disclosure) including a tank (22), a washing device (for example, 26Fa, 62, 64, 26R, 126R), and a control device (10, 20). The tank is configured to store washing liquid. The washing device is configured to wash a first washing target portion (for example, front window 60) and a second washing target portion (for example, rear lidar window portion 122R of rear lidar 12R) by using the stored washing liquid. The control device is configured to perform manual washing (step 650) in which the washing device is caused to wash at least the first washing target portion when a washing request is made by an occupant of the vehicle, determine whether the second washing target portion is dirty or not, and perform automatic washing (step 635) in which the washing device is caused to wash at least the second washing target portion when a determination is made that the second washing target portion is dirty (Yes in step 630).

Furthermore, the control device is configured not to perform the automatic washing (No in step 615) even when a determination is made that the second washing target portion is dirty in a case where a stored amount, which is the amount of the washing liquid stored in the tank, is equal to or smaller than a predetermined threshold amount (Yes in step 510).

In the case of the vehicle according to the aspect of the disclosure, the automatic washing is not performed even when a determination is made that the second washing target portion is dirty in a case where the amount of the washing liquid stored in the tank (stored amount) is equal to or smaller than the predetermined threshold amount. Therefore, the manual washing can necessarily be performed in a case where the occupant of the vehicle makes a washing request while the amount of washing liquid falls in a range from the predetermined threshold amount to zero. Since” a situation where the amount of washing liquid is excessively decreased and thus the manual washing cannot be performed although the manual washing has not been performed” does not occur, it is possible to decrease a possibility that the occupant of the vehicle feels a sense of incompatibility.

The vehicle according to the aspect of the disclosure may further include an information acquisition device (for example, rear lidar 12R) configured to receive an electromagnetic wave or an acoustic wave passing through a window portion and acquire information about an object positioned in the vicinity of the vehicle based on the received electromagnetic wave or the received acoustic wave. In this case, the first washing target portion is a front window (60) of the vehicle and the second washing target portion is the window portion (for example rear lidar window portion 122R).

In this case, it is possible for the occupant of the vehicle to perform the manual washing with respect to the front window until washing liquid runs out and thus it is possible to secure favorable visibility. Meanwhile, in the vehicle, the window portion of the information acquisition device is subjected to the automatic washing until the amount of washing liquid is decreased to become equal to or smaller than the threshold amount. Therefore, it is possible to cause the information acquisition device to acquire accurate information about the object and to use the information for driving assistance of the vehicle.

In the vehicle according to the aspect of the disclosure, the control device may be configured to determine whether the second washing target portion is dirty or not based on the information about the object acquired by the information acquisition device (step 415).

In this case, a sensor that detects whether the window portion of the information acquisition device is dirty or not does not need to be provided separately. Furthermore, it is possible to precisely determine whether the window portion of the information acquisition device is dirty or not.

In the vehicle according to the aspect of the disclosure, a first sensor (for example, rear lidar 12R) that receives an electromagnetic wave or an acoustic wave passing through a first window portion may be provided as the information acquisition device, and a second sensor (for example, front lidar 12F) that receives an electromagnetic wave or an acoustic wave passing through a second window portion may be provided.

In this case, the control device is configured to perform the automatic washing in which the washing device is caused to wash at least the first window portion as first automatic washing (step 635 in FIG. 8) when a determination is made that the first window portion as the second washing target portion is dirty (step 420 and step 425), determine whether the second window portion is dirty or not, perform second automatic washing (step 625 in FIG. 8) in which the washing device is caused to wash at least the second window portion when a determination is made that the second window portion is dirty (step 420 and step 425), perform no first automatic washing even when a determination is made that the first window portion is dirty and perform the second automatic washing when a determination is made that the second window portion is dirty (step 720, Yes in step 805, and No in step 810) in a case where the stored amount is equal to or smaller than a first threshold amount (VOL1th), which is the threshold amount, and is larger than a second threshold amount (VOL2th) smaller than the first threshold amount (Yes in step 715), perform no first automatic washing even when a determination is made that the first window portion is dirty and perform no second automatic washing even when a determination is made that the second window portion is dirty (step 725, No in step 805, and No in step 810) in a case where the stored amount is equal to or smaller than the second threshold amount (No in step 715).

In this case, it is possible to perform the automatic washing with respect to a window portion of the first sensor out of the window portion of the first sensor (for example, rear lidar 12R which is rear periphery sensor) and a window portion of the second sensor (for example, front lidar 12F which is front periphery sensor) until the amount of stored washing liquid becomes smaller. Accordingly, in a case where the second sensor is set to a sensor (for example, front lidar 12F) used in driving assistance control of which the importance is high, it is possible to lengthen a period where the driving assistance control of which the importance is high can be performed.

Note that, in the above-description, in order to facilitate understanding of the disclosure, both or one of a name and a reference numeral used in an embodiment which will be described later is given to a component according to the aspect of the disclosure that corresponds to the embodiment. However, each component according to the aspect of the disclosure is not limited to an embodiment defined with both or one of the name and the reference numeral. Another object, another feature, and an accompanied advantage of the disclosure will be easily understood from description on embodiments of the disclosure which will be made with reference to drawings as follows.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic system configuration diagram of a washing control device (first device) according to a first embodiment of the disclosure;

FIG. 2 is a top view of a vehicle for describing positions at which periphery sensors shown in FIG. 1 are attached to the vehicle;

FIG. 3 is a diagram for describing a connection relationship between pumps and nozzles respectively corresponding to the periphery sensors;

FIG. 4 is a flowchart showing a routine performed by a CPU of a driving assistance ECU shown in FIG. 1;

FIG. 5 is a flowchart showing a routine performed by a CPU of a washing control ECU shown in FIG. 1;

FIG. 6 is a flowchart showing a routine performed by the CPU of the washing control ECU shown in FIG. 1;

FIG. 7 is a flowchart showing a routine performed by a CPU of a washing control ECU according to a modification example of the first device;

FIG. 8 is a flowchart showing a routine performed by the CPU of the washing control ECU according to the modification example of the first device;

FIG. 9 is a diagram for describing a connection relationship between pumps and nozzles respectively corresponding to the periphery sensors, which are provided in a washing control device (second device) according to a second embodiment of the disclosure;

FIG. 10 is a flowchart showing a routine performed by a CPU of a washing control ECU according to the second device;

FIG. 11 is a flowchart showing a routine performed by a CPU of a washing control ECU according to a modification example of the second device; and

FIG. 12 is a flowchart showing a routine performed by the CPU of the washing control ECU according to the modification example of the second device.

### DETAILED DESCRIPTION OF EMBODIMENTS

### First Embodiment

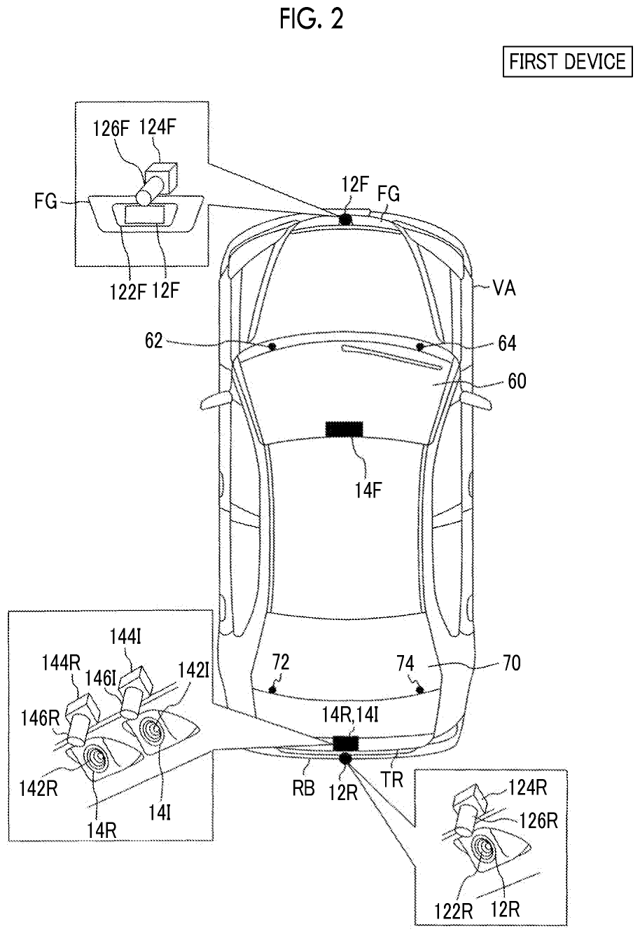

A washing control device (hereinafter, will be referred to as “first device”) according to a first embodiment of the disclosure is installed in a vehicle VA (refer to FIG. 2). The first device is provided with a driving assistance ECU (hereinafter, will be referred to as “DSECU”) 10, a washing control ECU (hereinafter, will be referred to as “WCECU”) 20, an engine ECU 30, a brake ECU 40 and a steering ECU 50. The ECUs are connected to each other such that the ECUs can exchange data with each other (can communicate with each other) via a controller area network (CAN) (not shown).

“ECU” is the abbreviation of “electronic control unit” and the ECU is an electronic control circuit that includes a microcomputer including a CPU, a ROM, a RAM, an interface, and the like as a main component. The CPU realizes various functions by executing an instruction (routine) stored in a memory (ROM). The ECUs or a part of the ECUs may be integrated into one ECU.

Note that, a CPU included in the DSECU 10 will be referred to as “CPU 11” and a CPU included in the WCECU 20 will be referred to as “CPU 21”.

Furthermore, the first device is provided with a front lidar (laser imaging detection and ranging (LIDAR)) 12F, a rear lidar 12R, a front camera 14F, a rear camera 14R, an inner mirror camera 14I, a center display 16, and an inner mirror display 18. These are connected to the DSECU 10.

The front lidar 12F, the rear lidar 12R, the front camera 14F, the rear camera 14R, and the inner mirror camera 14I are sensors acquiring information (hereinafter, will be referred to as “object information”) about an object in the vicinity of the vehicle VA. Note that, these may be referred to as “sensors” or “periphery sensors”.

As shown in FIG. 2, the front lidar 12F is disposed in the vicinity of the center of a front grille FG in a vehicle width direction, the front grille FG being on a front side of the vehicle VA. The front lidar 12F discharges light toward a detection region in front of the vehicle VA through a window portion 122F (hereinafter, may be referred to as “front lidar window portion 122F”). In addition, the front lidar 12F acquires object information by receiving light reflected by an object present in the detection region through the window portion 122F. The object information acquired by the front lidar 12F is information such as a direction from the front lidar 12F to the object and a distance from the front lidar 12F to the object.

A washing unit 124F is provided above the window portion 122F. The washing unit 124F includes a nozzle 126F (hereinafter, may be referred to as “front lidar nozzle 126F”). The washing unit 124F ejects washing liquid toward the window portion 122F through an ejection port (not shown) provided at a tip end of the nozzle 126F.

As shown in FIG. 2, the rear lidar 12R is disposed in the vicinity of the center of a rear bumper RB in the vehicle width direction, the rear bumper RB being on a rear side of the vehicle VA. The rear lidar 12R discharges light toward a detection region behind the vehicle VA through a window portion 122R (hereinafter, may be referred to as “rear lidar window portion 122R”). In addition, the rear lidar 12R acquires object information by receiving light reflected by an object present in the detection region through the window portion 122R. Note that, the object information acquired by the rear lidar 12R is information such as a direction from the rear lidar 12R to the object and a distance from the rear lidar 12R to the object.

Furthermore, a washing unit 124R is provided above the window portion 122R of the rear lidar 12R. The washing unit 124R includes a nozzle 126R (hereinafter, may be referred to as “rear lidar nozzle 126R”). The washing unit 124R ejects washing liquid toward the window portion 122R through an ejection port (not shown) provided at a tip end of the nozzle 126R.

As shown in FIG. 2, the front camera 14F is attached to the vicinity of the center of a roof front end of the vehicle VA in the vehicle width direction and is disposed in the vicinity of the center of an upper end of a front window 60 in the vehicle width direction. The front camera 14F images a region in front of the vehicle VA through the front window 60 by receiving natural light reflected by an object positioned in the region through the front window 60.

In this manner, the front camera 14F acquires object information based on an image of the region. The object information acquired by the front camera 14F is information such as a direction from the front camera 14F to the object, a distance from the front camera 14F to the object, the positions of mark lines (white lines) defining a lane, on which the vehicle VA travels, with respect to the front camera 14F, and the type of the object.

As shown in FIG. 2, the rear camera 14R and the inner mirror camera 14I are disposed to be adjacent to each other in the vehicle width direction in the vicinity of the center of a trunk TR in the vehicle width direction, the trunk TR being on the rear side of the vehicle VA.

The rear camera 14R images a region that is a part of a region behind the vehicle VA and is positioned relatively nearby through a window portion 142R (refer to FIG. 2) (hereinafter, may be referred to as rear camera window portion 142R) by receiving natural light reflected by an object positioned in the region through the window portion 142R.

In this manner, the rear camera 14R acquires object information based on an image of the region. The object information acquired by the rear camera 14R is information such as a direction from the rear camera 14R to the object, a distance from the rear camera 14R to the object, the positions of mark lines (white lines) defining a lane, on which the vehicle VA travels, with respect to the rear camera 14R, and the type of the object.

Furthermore, a washing unit 144R is provided above the window portion 142R. The washing unit 144R includes a nozzle 146R (hereinafter, may be referred to as “rear camera nozzle 146R”). The washing unit 144R ejects washing liquid toward the window portion 142R through an ejection port (not shown) provided at a tip end of the nozzle 146R.

The inner mirror camera 14I images a region that is a part of the region behind the vehicle VA and is positioned relatively far away through a window portion 142I (refer to FIG. 2) (hereinafter, may be referred to as inner mirror camera window portion 142I) by receiving natural light reflected by an object positioned in the region through the window portion 142I.

In this manner, the inner mirror camera 14I acquires object information based on an image of the region. The object information acquired by the inner mirror camera 14I is information such as a direction from the inner mirror camera 14I to the object, a distance from the inner mirror camera 14I to the object, the positions of mark lines (white lines) defining a lane, on which the vehicle VA travels, with respect to the inner mirror camera 14I, and the type of the object.

Furthermore, a washing unit 144I is provided above the window portion 142I. The washing unit 144I includes a nozzle 146I (hereinafter, may be referred to as “inner mirror camera nozzle 146I”). The washing unit 144I ejects washing liquid toward the window portion 142I through an ejection port (not shown) provided at a tip end of the nozzle 146I.

Note that, the window portions 122F, 122R, 142R, 142I are formed of translucent plate members.

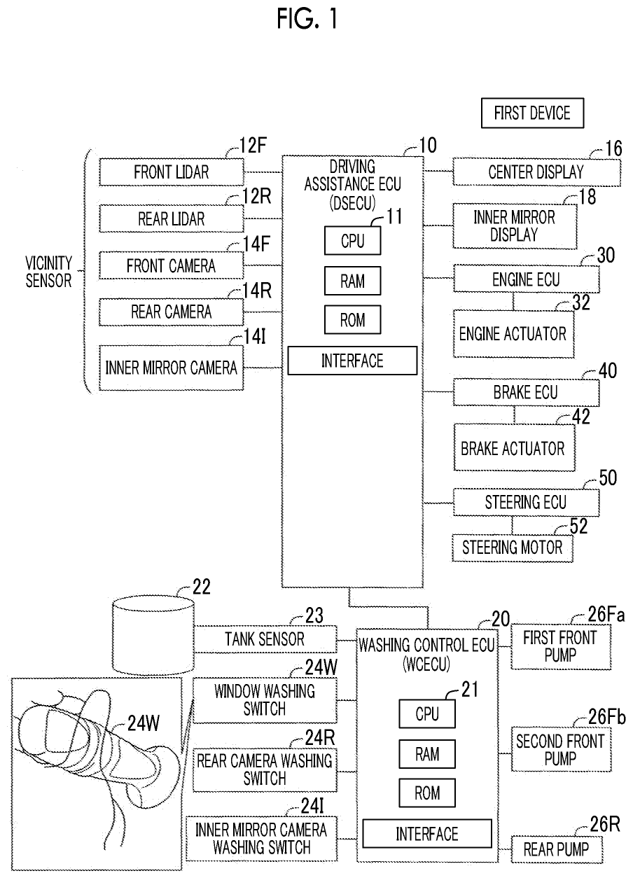

The center display 16 shown in FIG. 1 is provided in the vicinity of the center of an installment panel (not shown) in a vehicle cabin of the vehicle VA in the vehicle width direction (not shown). Map information or the like provided by a navigation system (not shown) is displayed on the center display 16. Furthermore, in a case where the vehicle VA moves backward or the like, an image captured by the rear camera 14R is displayed on the center display 16.

The inner mirror display 18 is provided in the vicinity of the center of a roof front end in the vehicle cabin of the vehicle VA in the vehicle width direction (not shown). An image captured by the inner mirror camera 14I is displayed on the inner mirror display 18.

The engine ECU 30 is connected to an engine actuator 32. The engine actuator 32 is a throttle valve actuator that changes the opening degree of a throttle valve of “an internal combustion engine (not shown) that is a drive source of the vehicle VA”. The engine ECU 30 changes torque generated by the internal combustion engine by driving the engine actuator 32. As a result, the engine ECU 30 can control the drive force of the vehicle VA.

The brake ECU 40 is connected to a brake actuator 42. The brake actuator 42 is a hydraulic pressure control actuator. The brake actuator 42 is provided in a hydraulic pressure circuit (not shown) between a master cylinder (not shown) that increases the pressure of hydraulic oil in accordance with a force by which the driver depresses a brake pedal (not shown) and a friction brake device (not shown) that includes a known wheel cylinder provided for each wheel. The brake actuator 42 adjusts hydraulic pressures supplied to the wheel cylinders and adjusts the braking force of the vehicle VA. Accordingly, the brake ECU 40 can decelerate the vehicle VA at a predetermined deceleration level by controlling the brake actuator 42.

The steering ECU 50 is a control device for a known electric power steering system and is connected to a steering motor 52. The steering motor 52 is incorporated into “a steering mechanism (not shown) including a steering wheel (not shown), a steering shaft (not shown) coupled to the steering wheel, a steering gear mechanism, and the like” of the vehicle VA. The steering motor 52 generates torque in response to an electric power of which the direction, the magnitude, and the like are controlled by the steering ECU 50 and applies steering assist torque by means of the generated torque or steers right and left steered wheels. That is, the steering motor 52 can change the steering angle of the vehicle VA. Note that, the electric power is supplied from a battery (not shown) installed in the vehicle VA.

Here, for which driving assistance control both or one of object information and an image from each periphery sensor is used will be described.

object information from the front lidar 12F and object information from the front camera 14F are used for “pre-collision control, cruising control, and lane change assistance control” which will be described later.

object information from the rear lidar 12R is used for the lane change assistance control.

An image from the rear camera 14R is displayed on the center display 16.

An image from the inner mirror camera 14I is displayed on the inner mirror display 18.

Accordingly, object information from the front lidar 12F and both or one of object information and an image from the front camera 14F are highest in importance in driving assistance control, object information from the rear lidar 12R is second highest in importance in the driving assistance control, and both or one of object information and an image from the rear camera 14R and both or one of object information and an image from the inner mirror camera 14I are lowest in importance in the driving assistance control.

Hereinafter, the pre-collision control, the cruising control, and the lane change assistance control will be described.

Pre-Collision Control

The pre-collision control is known control and the details thereof are described in Japanese Unexamined Patent Application Publication No. 2018-154285 (JP 2018-154285 A) and Japanese Unexamined Patent Application Publication No. 2019-003459 (JP 2019-003459 A). Hereinafter, simple description thereof will be made.

The DSECU 10 determines whether an object (obstacle) that is likely to collide with the vehicle VA is present in a region in front of the vehicle VA or not based on object information from the front lidar 12F and object information from the front camera 14F. In a case where the obstacle is present, the DSECU 10 performs deceleration control in which the vehicle VA is decelerated. More specifically, the DSECU 10 transmits a deceleration instruction to close the throttle valve to the engine ECU 30 and transmits “a deceleration instruction for deceleration of the vehicle VA at a predetermined deceleration level” to the brake ECU 40. As a result, the vehicle VA is decelerated at the predetermined deceleration level and thus collision can be avoided.

Cruising Control

The cruising control is known control and the details thereof are described in Japanese Unexamined Patent Application Publication No. 2015-072604 (JP 2015-072604 A). Hereinafter, simple description thereof will be made.

The DSECU 10 determines whether a preceding vehicle traveling immediately ahead of the vehicle VA is present or not based on object information from the front lidar 12F and object information from the front camera 14F. In a case where the preceding vehicle is not present, the DSECU 10 controls the engine ECU 30 and the brake ECU 40 such that the speed of the vehicle VA (vehicle speed) coincides with a set speed set in advance. More specifically, in a case where the vehicle speed is lower than the set speed, the DSECU 10 transmits an acceleration instruction to increase the opening degree of the throttle valve to the engine ECU 30. Meanwhile, in a case where the vehicle speed is higher than the set speed, the DSECU 10 transmits a deceleration instruction to the engine ECU 30 (and to brake ECU 40 as needed).

In a case where the preceding vehicle is present, the DSECU 10 causes the vehicle VA to travel such that a vehicle-to-vehicle distance between the vehicle VA and the preceding vehicle is maintained at a predetermined target vehicle-to-vehicle distance. More specifically, in a case where the vehicle-to-vehicle distance is larger than the predetermined distance, the DSECU 10 transmits an acceleration instruction to the engine ECU 30. Meanwhile, in a case where the vehicle-to-vehicle distance is smaller than the predetermined distance, the DSECU 10 transmits a deceleration instruction to the engine ECU 30 (and to brake ECU 40 as needed).

Lane Change Assistance Control

The lane change assistance control is known control and the details thereof are described in Japanese Unexamined Patent Application Publication No. 2019-003235 (JP 2019-003235 A). Hereinafter, simple description thereof will be made.

The DSECU 10 detects a white line on a road based on object information from the front camera 14F. Then, the DSECU 10 obtains, based on the detected white line, a relative distance between the vehicle VA and each of a traveling lane, on which the vehicle VA is currently travelling, and an adjacent lane adjacent to the traveling lane in a lane width direction. When there is a request for a change to the adjacent lane from a driver, the DSECU 10 acquires the position of a front side vehicle traveling ahead of the vehicle VA at the adjacent lane relative to the vehicle VA and the speed of the front side vehicle relative to the vehicle VA based on object information from the front lidar 12F and the object information from the front camera 14F. Furthermore, the DSECU 10 acquires the position of a rear side vehicle traveling behind the vehicle VA at the adjacent lane relative to the vehicle VA and the speed of the rear side vehicle relative to the vehicle VA based on object information from the rear lidar 12R. Then, the DSECU 10 determines, based on the position and the relative speed of the front side vehicle and the position and the relative speed of the rear side vehicle, a target route for a change to the adjacent lane of the vehicle VA such that the vehicle VA does not excessively approach any of the front side vehicle and the rear side vehicle. The DSECU 10 transmits an instruction signal to the engine ECU 30, the brake ECU 40, and the steering ECU 50 such that the vehicle VA travels along the target traveling route.

Furthermore, as shown in FIG. 1, the first device is provided with a tank 22 in which washing liquid is stored, a tank sensor (remaining washing liquid amount sensor) 23, a window washing switch 24W, a rear camera washing switch 24R, an inner mirror camera washing switch 24I, a first front pump 26Fa, a second front pump 26Fb, and a rear pump 26R. The tank sensor 23, the various switches 24W to 24I, and the various pumps 26Fa to 26R are connected to the WCECU 20.

The tank 22 is a container in which washing liquid is stored. The tank 22 is provided with a cap and an opening (which are not shown). The tank 22 can be replenished with washing liquid through the opening in a state where the cap is detached. The cap is mounted on the container such that the opening is closed except when the container is replenished with washing liquid.

The tank sensor 23 measures the volume of washing liquid stored in the tank 22 (hereinafter, will be referred to as “stored amount VOL” or “remaining washing liquid amount VOL”) and transmits a stored amount signal indicating the stored amount VOL to the WCECU 20.

The window washing switch 24W is provided in the vicinity of a steering handle (not shown) of the vehicle VA. The window washing switch 24W is a switch that is operated by the driver in a case where the driver requests washing of any of “the front window 60 and a rear window 70” shown in FIG. 2.

As shown in FIG. 1, the window washing switch 24W is provided with a rod-shaped lever that the driver can hold. The lever is configured to be able to be tilted in a vehicle front direction and a vehicle rear direction around a supporting point. In a case where the driver requests washing of the front window 60, the driver tilts the window washing switch 24W toward the driver side (that is, to vehicle rear side). While the window washing switch 24W is being tilted toward the driver side by the driver, a manual washing request (that is, manual washing request signal for front window) indicating that “the driver is requesting washing of the front window 60” is continuously transmitted to the WCECU 20. In the case of the above-described manual washing request, the front window 60 is designated as a washing target (washing target portion).

Meanwhile, in a case where the driver requests washing of the rear window 70, the driver tilts the window washing switch 24W toward a side opposite to the driver side (that is, to vehicle front side). While the window washing switch 24W is being tilted toward the side opposite to the driver side by the driver, a manual washing request (that is, manual washing request signal for rear window) indicating that “the driver is requesting washing of the rear window 70” is continuously transmitted to the WCECU 20. In the case of the above-described manual washing request, the rear window 70 is designated as a washing target.

The rear camera washing switch 24R is provided in the vicinity of the steering handle (not shown) and is a switch that the driver operates in a case where the driver requests washing of the window portion 142R of the rear camera 14R. While the rear camera washing switch 24R is being operated by the driver, a manual washing request (that is, manual washing request signal for rear camera) indicating that “the driver is requesting washing of the window portion 142R” is continuously transmitted to the WCECU 20. In the case of the above-described manual washing request, the rear camera 14R (more specifically, rear camera window portion 142R) is designated as a washing target.

The inner mirror camera washing switch 24I is provided in the vicinity of the steering handle (not shown) and is a switch that the driver operates in a case where the driver requests washing of the window portion 142I of the inner mirror camera 14I. While the inner mirror camera washing switch 24I is being operated by the driver, a manual washing request (that is, manual washing request signal for inner mirror camera) indicating that “the driver is requesting washing of the window portion 142I” is continuously transmitted to the WCECU 20. In the case of the above-described manual washing request, the inner mirror camera 14I (more specifically, inner mirror camera window portion 142I) is designated as a washing target.

The first front pump 26Fa sucks up washing liquid from the tank 22 and ejects the washing liquid through front window nozzles 62, 64 (refer to FIG. 2). As shown in FIG. 2, the front window nozzle 62 is provided on a left side of a lower end of the front window 60 and the front window nozzle 64 is provided on a right side of the lower end of the front window 60. An ejection port facing the front window 60 is formed in each of the front window nozzles 62, 64. Therefore, washing liquid ejected through the ejection port of each of the front window nozzles 62, 64 is ejected toward the front window 60.

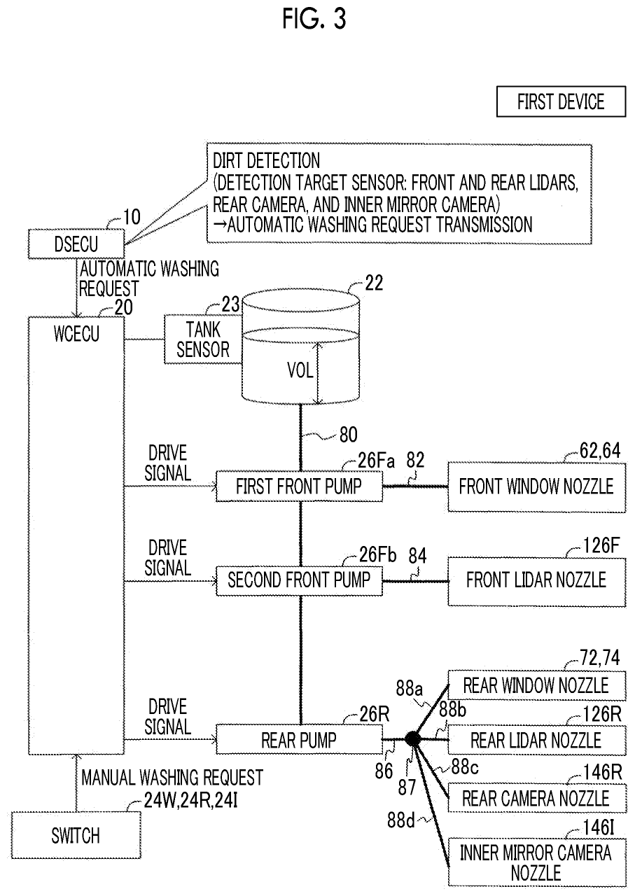

As shown in FIG. 3, the tank 22 is connected to an inflow port of each of the first front pump 26Fa, the second front pump 26Fb, and the rear pump 26R via a supply path 80. Furthermore, a discharge port of the first front pump 26Fa is connected to the front window nozzles 62, 64 via a front window path 82.

In a case where the first front pump 26Fa is driven, the first front pump 26Fa sucks up washing liquid stored in the tank 22 via the supply path 80 and ejects the sucked up washing liquid toward the front window 60 through the front window nozzles 62, 64 via the front window path 82. As a result, the front window 60 is washed.

As shown in FIG. 3, a discharge port of the second front pump 26Fb is connected to the front lidar nozzle 126F via a front lidar path 84. In a case where the second front pump 26Fb is driven, the second front pump 26Fb sucks up washing liquid stored in the tank 22 via the supply path 80 and ejects the sucked up washing liquid toward the front lidar window portion 122F through the front lidar nozzle 126F via the front lidar path 84. As a result, the front lidar window portion 122F is washed.

As shown in FIG. 3, a discharge port of the rear pump 26R is connected to rear window nozzles 72, 74, the rear lidar nozzle 126R, the rear camera nozzle 146R, and the inner mirror camera nozzle 146I. More specifically, a first end of a flow path 86 shown in FIG. 3 is connected to the discharge port of the rear pump 26R. A second end of the flow path 86 branches into four flow paths 88a to 88d at a junction portion 87. The flow path 88a is connected to the rear window nozzles 72, 74. The flow path 88b is connected to the rear lidar nozzle 126R. The flow path 88c is connected to the rear camera nozzle 146R. The flow path 88d is connected to the inner mirror camera nozzle 146I.

In a case where the rear pump 26R is driven, the rear pump 26R sucks up washing liquid stored in the tank 22 via the supply path 80 and ejects the sucked up washing liquid through all of the nozzles 72, 74, 126R, 146R, 146I via the flow paths 88a to 88d at once.

As shown in FIG. 2, the rear window nozzle 72 is provided on a left side of a lower end of the rear window 70 and the rear window nozzle 74 is provided on a right side of the lower end of the rear window 70. An ejection port facing the rear window 70 is formed in each of the rear window nozzles 72, 74. Therefore, washing liquid ejected through the ejection port of each of the rear window nozzles 72, 74 is ejected toward the rear window 70.

Accordingly, in a case where the rear pump 26R is driven, washing liquid is ejected toward the rear window 70, the rear lidar window portion 122R, the rear camera window portion 142R, and the inner mirror camera window portion 142I such that the rear window 70, the rear lidar window portion 122R, the rear camera window portion 142R, and the inner mirror camera window portion 142I are washed.

Outline of Operation

The first device performs “automatic washing and manual washing” which will be described later. However, in a case where the stored amount VOL is equal to or smaller than a threshold amount VOLth, the first device prohibits the automatic washing. Therefore, the automatic washing can be performed until the stored amount VOL becomes equal to or smaller than the threshold amount VOLth and the manual washing can necessarily be performed in a case where an occupant (for example, driver) of the vehicle requests the manual washing while the stored amount VOL falls in a range from the threshold amount VOLth to zero. Since a situation where the amount of washing liquid is excessively decreased such that the manual washing cannot be performed although the manual washing has not been performed does not occur, it is possible to decrease a possibility that the occupant of the vehicle feels a sense of incompatibility.

Automatic Washing

The DSECU 10 determines whether each of the front lidar window portion 122F, the rear lidar window portion 122R, the rear camera window portion 142R, and the inner mirror camera window portion 142I is dirty or not each time a predetermined time elapses.

Once the DSECU 10 determines that at least one of the window portions 122F, 122R, 142R, 142I is dirty, the DSECU 10 continuously transmits, to the WCECU 20 for a predetermined time, an automatic washing request indicating that washing of the window portion determines as being dirty is requested. In the case of the above-described automatic washing request, the window portion determined as being dirty is designated as a washing target. Note that, in a case where a plurality of window portions is determined as being dirty, the window portions are designated as washing targets by means of the automatic washing request. Note that, a periphery sensor corresponding to a window portion determined as being dirty may be referred to as “dirty periphery sensor”.

In a case where the WCECU 20 receives an automatic washing request and the stored amount VOL is larger than the threshold amount VOLth, the WCECU 20 transmits a drive signal to a pump corresponding to a washing target designated by means of the received automatic washing request. For example, in a case where the front lidar window portion 122F is designated by means of the automatic washing request, the WCECU 20 transmits a drive signal to the second front pump 26Fb. As a result, washing liquid is ejected toward the front lidar window portion 122F and thus the front lidar window portion 122F is washed. Meanwhile, in a case where at least one of the rear lidar window portion 122R, the rear camera window portion 142R, and the inner mirror camera window portion 142I is designated by means of the automatic washing request, the WCECU 20 transmits a drive signal to the rear pump 26R. As a result, washing liquid is ejected toward all of the rear window 70, the rear lidar window portion 122R, the rear camera window portion 142R, and the inner mirror camera window portion 142I at once and thus the rear window 70 and the window portions 122R, 142R, 142I are washed.

Note that, the DSECU 10 does not determine whether a window portion of the front camera 14F (that is, portion of front window 60 that is positioned ahead of front camera 14F) is dirty or not. Therefore, the WCECU 20 does not transmit a drive signal based on an automatic washing request to the first front pump 26Fa. In other words, the front window 60 is not washed by means of an automatic washing request.

“Control in which the WCECU 20 performs washing of a washing target window portion based on an automatic washing request” as described above will be referred to as “automatic washing”.

In a case where the stored amount VOL is equal to or smaller than the threshold amount VOLth, the WCECU 20 does not transmit a drive signal even when the WCECU 20 receives an automatic washing request. As a result, the automatic washing is prohibited in a case where the stored amount VOL is equal to or smaller than the threshold amount VOLth.

Manual Washing

In a case where the WCECU 20 receives a manual washing request from any of the window washing switch 24W, the rear camera washing switch 24R, and the inner mirror camera washing switch 24I, the WCECU 20 performs the manual washing regardless of the stored amount VOL.

More specifically, in a case where the front window 60 is designated as a washing target by means of the received manual washing request, the WCECU 20 transmits a drive signal to the first front pump 26Fa such that the front window 60 is washed.

Meanwhile, in a case where any of the rear window 70, the rear camera window portion 142R, and the inner mirror camera window portion 142I is designated as a washing target by means of the received manual washing request, the WCECU 20 transmits a drive signal to the rear pump 26R such that all of the rear window 70, the rear camera window portion 142R, and the inner mirror camera window portion 142I are washed at once. Specific Operation

Automatic Washing Request Transmission Routine

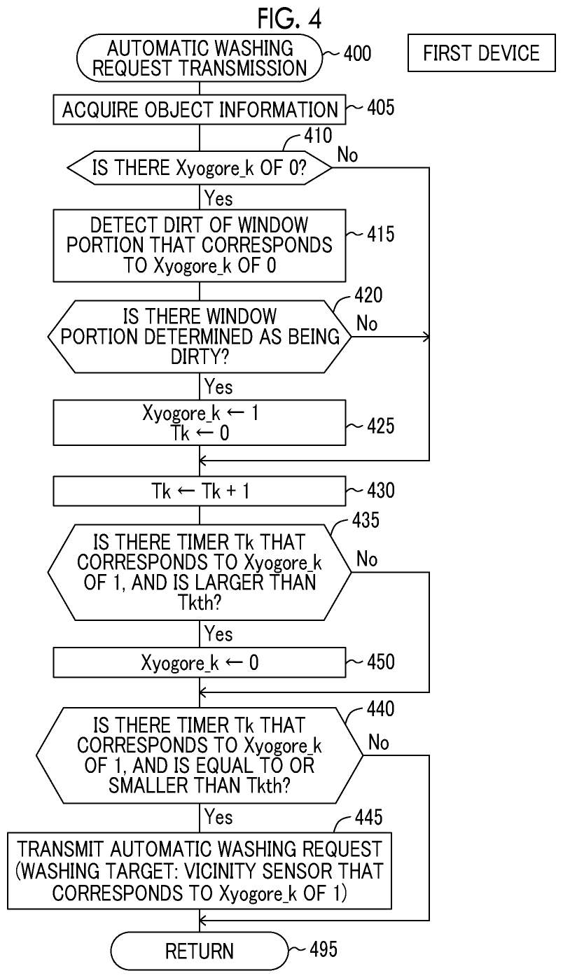

The CPU 11 of the DSECU 10 performs a routine (automatic washing request transmission routine) shown in a flowchart in FIG. 4 each time a predetermined time elapses.

Therefore, when a predetermined timing is reached, the CPU 11 starts a process from step 400 in FIG. 4, performs step 405, and proceeds to step 410.

Step 405: The CPU 11 acquires both or one of object information and an image from each of the front lidar 12F, the rear lidar 12R, the rear camera 14R, and the inner mirror camera 14I.

Step 410: Determination on whether the value of any of dirt flags Xyogore_FL, Xyogore_RL, Xyogore_RC, Xyogore_IC is “0” or not is performed.

The value of the dirt flag Xyogore_FL is set to “1” in a case where a determination is made that the front lidar window portion 122F is dirty. The value of the dirt flag Xyogore_RL is set to “1” in a case where a determination is made that the rear lidar window portion 122R is dirty. The value of the dirt flag Xyogore_RC is set to “1” in a case where a determination is made that the rear camera window portion 142R is dirty. The value of the dirt flag Xyogore_IC is set to “1” in a case where a determination is made that the inner mirror camera window portion 142I is dirty.

Note that, the value of each dirt flag Xyogore_k (k=FL, RL, RC, IC) is set to “0” when a predetermined time (time corresponding to threshold time Tkth which will be described later) elapses after a time at which a determination is made that dirt is present (that is, time at which value is changed to “1” from “0”). Furthermore, the value of each dirt flag Xyogore_k is set to “0” in an initial routine that is performed by the DSECU 10 when the position of an ignition key switch (not shown) of the vehicle VA is changed to an ON position from an OFF position.

In a case where there is a dirt flag Xyogore_k of which the value has been set to “0”, the result of the determination performed by the CPU 11 in step 410 becomes “Yes” and the CPU 11 proceeds to step 415.

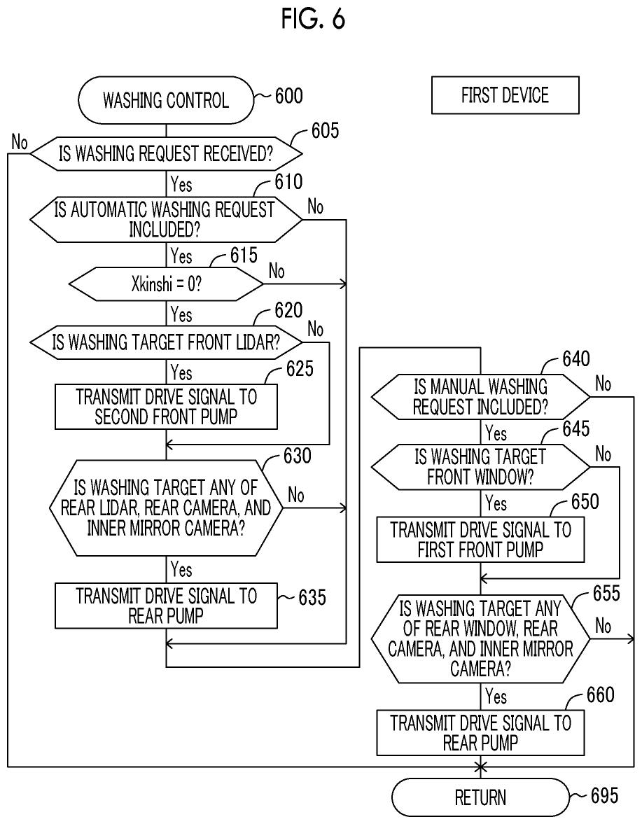

In step 415, the CPU 11 determines whether “one window portion from among the front lidar window portion 122F, the rear lidar window portion 122R, the rear camera window portion 142R, and the inner mirror camera window portion 142I that corresponds to the dirt flag Xyogore_k of which the value is “0” and is not in the middle of washing” is dirty or not based on both or one of the object information and the image acquired in step 405. In a case where a window portion is in the middle of washing, there is a high possibility that the window portion is determined as being dirty. Therefore, a window portion to be subject to determination on whether the window portion is dirty or not is limited to a window portion that is not in the middle of washing. Note that, the DSECU 10 receives “information specifying which portion is in the middle of washing” from the WCECU 20 when washing (ejection of washing liquid) is performed with the CPU 21 of the WCECU 20 performing a routine shown in FIG. 6 (which will be described later).

A process in step 415 will be described in detail.

In a case where the value of the dirt flag Xyogore_FL is “0” and the front lidar window portion 122F is not in the middle of washing, the CPU 11 determines whether at least one of condition 1 and condition 2 as follows is satisfied or not based on object information from the front lidar 12F. In a case where at least one of condition 1 and condition 2 is satisfied, the CPU 11 determines that the front lidar window portion 122F is dirty.

Condition 1: An object of which a distance D to the front lidar 12F is equal to or shorter than “a threshold distance Dth set to a very small value” is continuously detected for a predetermined time.

Condition 2: An object detected by the front lidar 12F the predetermined time ago becomes no longer detected suddenly.

In a case where the value of the dirt flag Xyogore_RL is “0” and the rear lidar window portion 122R is not in the middle of washing, the CPU 11 determines whether at least one of condition 1′ and condition 2′ as follows is satisfied or not based on object information from the rear lidar 12R. In a case where at least one of condition 1′ and condition 2′ is satisfied, the CPU 11 determines that the rear lidar window portion 122R is dirty.

Condition 1′: An object of which the distance D to the rear lidar 12R is equal to or shorter than “the threshold distance Dth set to a very small value” is continuously detected for a predetermined time.

Condition 2′: An object detected by the rear lidar 12R the predetermined time ago becomes no longer detected suddenly.

In a case where the value of the dirt flag Xyogore_RC is “0” and the rear camera window portion 142R is not in the middle of washing, the CPU 11 determines whether the rear camera window portion 142R is dirty or not based on the edge strength of an image from the rear camera 14R (hereinafter, may be referred to as “rear camera image”). Such a dirt detection method based on an edge strength is a known method and is described in Japanese Unexamined Patent Application Publication No. 2015-95886 (JP 2015-95886 A). Furthermore, in a case where the value of the dirt flag Xyogore_IC is “0” and the inner mirror camera window portion 142I is not in the middle of washing, the CPU 11 determines whether the inner mirror camera window portion 142I is dirty or not based on the edge strength of an image from the inner mirror camera 14I (hereinafter, may be referred to as “inner mirror camera image”).

Step 420: The CPU 11 determines whether or not there is a window portion determined as being dirty (hereinafter, will be referred to as “dirty window portion”) in step 415.

In a case where there is a dirty window portion, the result of the determination performed by the CPU 11 in step 420 becomes “Yes” and the CPU proceeds to step 435 after performing step 425 and step 430 in this order.

Step 425: The CPU 11 sets the value of the dirt flag Xyogore_k corresponding to the dirty window portion to “1” and sets a timer Tk out of timers Tfr, Trr, Trc, Tic that corresponds to the dirty window portion to “0”.

Step 430: The CPU 11 adds “1” to a timer Tk out of the timers Tfr, Trr, Trc, Tic corresponding to a dirt flag Xyogore_k of which the value is “1”.

The timer Tfr measures a time that elapses from a time at which the front lidar window portion 122F is determined as being dirty. The timer Trr measures a time that elapses from a time at which the rear lidar window portion 122R is determined as being dirty. The timer Trc measures a time that elapses from a time at which the rear camera window portion 142R is determined as being dirty. The timer Tic measures a time that elapses from a time at which the inner mirror camera window portion 142I is determined as being dirty.

Step 435: The CPU 11 determines whether or not there is a timer Tk that corresponds to a dirt flag Xyogore_k, of which the value is “1”, and is larger than the threshold time Tkth.

In a case where there is no timer Tk as described above, the result of the determination performed by the CPU 11 in step 435 becomes “No” and the CPU 11 proceeds to step 440. In step 440, the CPU 11 determines whether or not there is a timer Tk that corresponds to a dirt flag Xyogore_k, of which the value is “1”, and is equal to or smaller than the threshold time Tkth.

In a case where there is a timer Tk as described above, the result of the determination performed by the CPU 11 in step 440 becomes “Yes” and the CPU 11 proceeds to step 445. In step 445, the CPU 11 transmits an automatic washing request in which a window portion corresponding to the timer Tk is designated as a washing target to the WCECU 20 and proceeds to step 495 such that the present routine is temporarily terminated. Note that, the automatic washing request is continuously generated until the next time the CPU 11 performs step 440 of the present routine.

Meanwhile, in a case where there is a timer Tk as described in step 435 at a time at which the CPU 11 proceeds to step 435, the result of the determination performed by the CPU 11 in step 435 becomes “Yes” and the CPU 11 proceeds to step 450. In step 450, the CPU 11 sets a dirt flag Xyogore_k corresponding to the timer Tk to “0” and proceeds to step 440.

Meanwhile, in a case where there is no “timer Tk that corresponds to a dirt flag Xyogore_k, of which the value is “1”, and is equal to or smaller than the threshold time Tkth” in step 440 at a time at which the CPU 11 proceeds to step 440, the result of the determination performed by the CPU 11 in step 440 becomes “No” and the CPU 11 proceeds to step 495 such that the present routine is temporarily terminated. As a result, no automatic washing request is transmitted.

Meanwhile, in a case where there is no dirty window portion at a time at which the CPU 11 proceeds to step 420, the result of the determination performed by the CPU 11 in step 420 becomes “No” and the CPU 11 proceeds to step 430.

Note that, in a case where the values of all of the dirt flags Xyogore_k are “1” at a time at which the CPU 11 proceeds to step 410, the result of the determination performed by the CPU 11 in step 410 becomes “No” and the CPU 11 proceeds to step 430.

As described above, once the CPU 11 determines that a window portion is dirty, the CPU 11 transmits an automatic washing request, in which the window portion (dirty periphery sensor) determined as being dirty is designated as a washing target, to the WCECU 20 until a predetermined time elapses.

Prohibition Flag Setting Routine

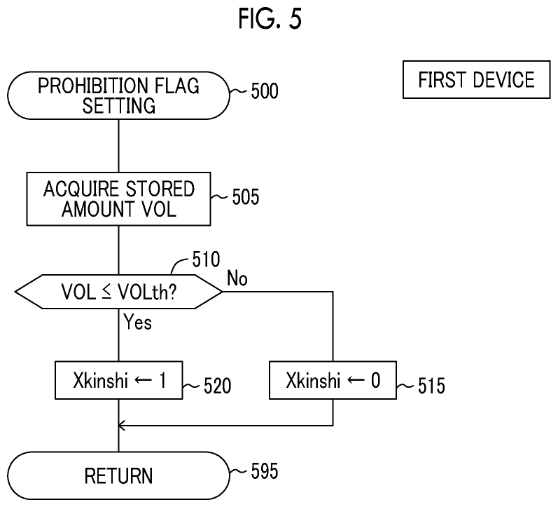

The CPU 21 of the WCECU 20 performs a routine (prohibition flag setting routine) shown in a flowchart in FIG. 5 each time a predetermined time elapses.

Therefore, when a predetermined timing is reached, the CPU 21 starts a process from step 500 in FIG. 5, performs step 505, and proceeds to step 510.

Step 505: The CPU 21 acquires the stored amount VOL indicated by a stored amount signal received by the tank sensor 23.

Step 510: The CPU 21 determines whether the stored amount VOL acquired in step 505 is equal to or smaller than the threshold amount VOLth or not.

In a case where the stored amount VOL is larger than the threshold amount VOLth, the result of the determination performed by the CPU 21 in step 510 becomes “No” and the CPU 21 proceeds to step 515. In step 515, the CPU 21 sets the value of a prohibition flag Xkinshi to “0” and proceeds to step 595 such that the present routine is temporarily terminated. Note that, the WCECU 20 sets the prohibition flag Xkinshi to “0” at the above-described initial routine.

Meanwhile, in a case where the stored amount VOL is equal to or smaller than the threshold amount VOLth at a time at which the CPU 21 proceeds to step 510, the result of the determination performed by the CPU 21 in step 510 becomes “Yes” and the CPU 21 proceeds to step 520. In step 520, the CPU 21 sets the value of a prohibition flag Xkinshi to “1” and proceeds to step 595 such that the present routine is temporarily terminated.

Washing Control Routine

The CPU 21 performs a routine (washing control routine) shown in a flowchart in FIG. 6 each time a predetermined time elapses.

Therefore, when a predetermined timing is reached, the CPU 21 starts a process from step 600 in FIG. 6, proceeds to step 605, and determines whether at least one of an automatic washing request and a manual washing request has been received or not.

In a case where at least one of an automatic washing request and a manual washing request has been received, the result of the determination performed by the CPU 21 in step 605 becomes “Yes” and the CPU 21 proceeds to step 610.

In step 610, the CPU 21 determines whether the received washing requests include an automatic washing request or not.

In a case where the received washing requests include an automatic washing request, the result of the determination performed by the CPU 21 in step 610 becomes “Yes” and the CPU 21 proceeds to step 615.

In step 615, the CPU 21 determines whether the prohibition flag Xkinshi is “0” or not. In a case where the prohibition flag Xkinshi is “0”, the result of the determination performed by the CPU 21 in step 615 becomes “Yes” and the CPU 21 proceeds to step 620.

In step 620, the CPU 21 determines whether washing targets designated by means of the received automatic washing request include the front lidar window portion 122F or not. In a case where the washing targets include the front lidar window portion 122F, the result of the determination performed by the CPU 21 in step 620 becomes “Yes” and the CPU 21 proceeds to step 630 after performing step 625.

Step 625: The CPU 21 transmits a drive signal to the second front pump 26Fb. As a result, the front lidar window portion 122F is washed. Furthermore, the CPU 21 transmits, to the DSECU 10, information indicating that the front lidar window portion 122F is in the middle of washing.

Step 630: The CPU 21 determines whether the washing targets designated by means of the received automatic washing request include at least one of the rear lidar window portion 122R, the rear camera window portion 142R, and the inner mirror camera window portion 142I or not. In other words, in step 630, the CPU 21 determines whether the washing targets designated by means of the received automatic washing request include “a window portion of a periphery sensor other than the front lidar 12F” or not.

In a case where the washing targets include “a window portion of a periphery sensor other than the front lidar 12F”, the result of the determination performed by the CPU 21 in step 630 becomes “Yes” and the CPU 21 proceeds to step 640 after performing step 635.

Step 635: The CPU 21 transmits a drive signal to the rear pump 26R. As a result, all of the rear window 70, the rear lidar window portion 122R, the rear camera window portion 142R, and the inner mirror camera window portion 142I are washed at once. Furthermore, in step 635, the CPU 21 transmits, to the DSECU 10, information indicating that the rear window 70, the rear lidar window portion 122R, the rear camera window portion 142R, and the inner mirror camera window portion 142I are in the middle of washing.

Step 640: The CPU 21 determines whether the received washing requests include a manual washing request or not.

In a case where the received washing requests include a manual washing request, the result of the determination performed by the CPU 21 in step 640 becomes “Yes” and the CPU 21 proceeds to step 645. In step 645, the CPU 21 determines whether the washing targets designated by means of the received manual washing request include the front window 60 or not. In a case where the washing targets include the front window 60, the result of the determination performed by the CPU 21 in step 645 becomes “Yes” and the CPU 21 proceeds to step 655 after performing step 650.

Step 650: The CPU 21 transmits a drive signal to the first front pump 26Fa. As a result, the front window 60 is washed.

Step 655: The CPU 21 determines whether the washing targets of the manual washing request included in the received washing requests include at least one of the rear window 70, the rear camera window portion 142R, and the inner mirror camera window portion 142I or not.

In a case where the washing targets include at least one of the rear window 70, the rear camera window portion 142R, and the inner mirror camera window portion 142I, the result of the determination performed by the CPU 21 in step 655 becomes “Yes” and the CPU 21 proceeds to step 695 after performing step 660 such that the present routine is temporarily terminated.

Step 660: The CPU 21 transmits a drive signal to the rear pump 26R. As a result, all of the rear window 70, the rear lidar window portion 122R, the rear camera window portion 142R, and the inner mirror camera window portion 142I are washed at once. Furthermore, in step 660, the CPU 21 transmits, to the DSECU 10, information indicating that the rear window 70, the rear lidar window portion 122R, the rear camera window portion 142R, and the inner mirror camera window portion 142I are in the middle of washing.

Meanwhile, in a case where any of an automatic washing request and a manual washing request is not received by the CPU 21 before the CPU 21 proceeds to step 605, the result of the determination performed by the CPU 21 in step 605 becomes “No” and the CPU 21 proceeds to step 695 so that the present routine is temporarily terminated.

Furthermore, in a case where the received washing requests do not include an automatic washing request at a time at which the CPU 21 proceeds to step 610, the result of the determination performed by the CPU 21 in step 610 becomes “No” and the CPU 21 proceeds to step 640 directly.

In addition, in a case where the prohibition flag Xkinshi is “1” at a time at which the CPU 21 proceeds to step 615, the result of the determination performed by the CPU 21 in step 615 becomes “No” and the CPU 21 proceeds to step 640 directly. As a result, even in a case where an automatic washing request is received, the CPU 21 does not transmit a drive signal to any pump (any of pumps 26Fa, 26Fb, 26R) when the stored amount VOL is equal to or smaller than the threshold amount VOLth (that is, when prohibition flag Xkinshi is set to “1”). In this manner, the CPU 21 can prohibit the automatic washing.

In a case where the washing targets of the automatic washing request do not include the front lidar window portion 122F at a time at which the CPU 21 proceeds to step 620, the result of the determination performed by the CPU 21 in step 620 becomes “No” and the CPU 21 proceeds to step 630 directly.

In a case where the washing targets of the automatic washing request do not include any of the rear lidar window portion 122R, the rear camera window portion 142R, and the inner mirror camera window portion 142I at a time at which the CPU 21 proceeds to step 630, the result of the determination performed by the CPU 21 in step 630 becomes “No” and the CPU 21 proceeds to step 640 directly.

In a case where the received washing requests do not include a manual washing request at a time at which the CPU 21 proceeds to step 640, the result of the determination performed by the CPU 21 in step 640 becomes “No” and the CPU 21 proceeds to step 695 directly such that the present routine is temporarily terminated.

In a case where the washing targets designated by means of the received manual washing request do not include the front window 60 at a time at which the CPU 21 proceeds to step 645, the result of the determination performed by the CPU 21 in step 645 becomes “No” and the CPU 21 proceeds to step 655 directly.

In a case where the washing targets of the manual washing request included in the received washing requests do not include any of the rear window 70, the rear camera window portion 142R, and the inner mirror camera window portion 142I at a time at which the CPU 21 proceeds to step 655, the result of the determination performed by the CPU 21 in step 655 becomes “No” and the CPU 21 proceeds to step 695 directly such that the present routine is temporarily terminated.

As described above, the first device prohibits the automatic washing in a case where the stored amount VOL is equal to or smaller than the threshold amount VOLth. Therefore, the first device can prevent the stored amount VOL from becoming “a minute amount smaller than the threshold amount VOLth” without being noticed by the driver. Accordingly, the first device can reliably perform the manual washing in a case where the driver requests the manual washing.

### Modification Example of First Device

A washing control device (hereinafter, will be referred to as “first modification device”) according to a modification example of the first device is different from the first device in a point as follows.

A threshold amount for prohibition of automatic washing with respect to the rear lidar window portion 122R, the rear camera window portion 142R, and the inner mirror camera window portion 142I and a threshold amount for prohibition of automatic washing with respect to the front lidar window portion 122F are set to be different from each other. Note that, the former automatic washing may be referred to as “rear side automatic washing” or “first automatic washing” and the latter automatic washing may be referred to as “front side automatic washing” or “second automatic washing”.

More specifically, the threshold amount for prohibition of the rear side automatic washing is set to a first threshold amount VOL1th. The threshold amount for prohibition of the front side automatic washing is set to “a second threshold amount VOL2th smaller than the first threshold amount VOL1th”. That is, the first modification device prohibits the rear side automatic washing in a case where the stored amount VOL is equal to or smaller than the first threshold amount VOL1th and is larger than the second threshold amount VOL2th and prohibits both of the rear side automatic washing and the front side automatic washing in a case where the stored amount VOL is equal to or smaller than the second threshold amount VOL2th.

As described above, object information from the front lidar 12F is higher than object information from the rear lidar 12R, object information and an image from the rear camera 14R, and object information and an image from the inner mirror camera 14I in importance in driving assistance control. Therefore, for the first modification device, a timing at which the front side automatic washing is prohibited is set to be later than a timing at which the rear side automatic washing is prohibited with the second threshold amount VOL2th set to be smaller than the first threshold amount VOL1th. Therefore, it is possible to perform “driving assistance control with use of object information from the front lidar 12F” for a longer period of time.

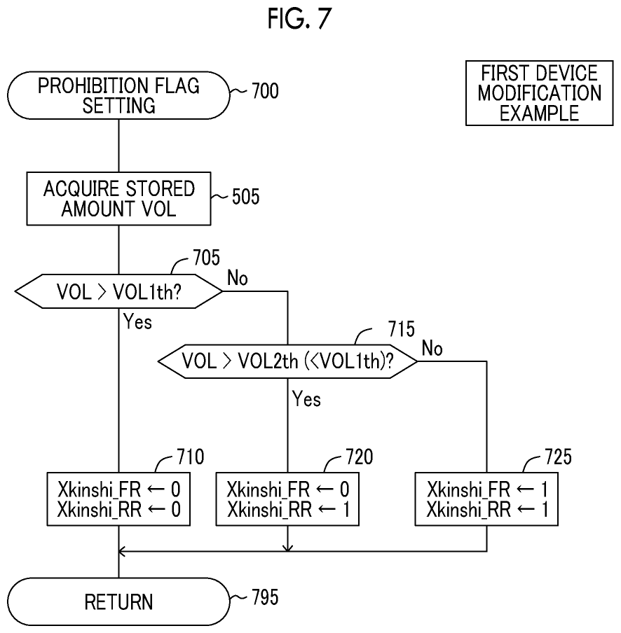

Since the CPU 11 of the first modification device performs the substantially same routine as the CPU 11 of the first device, description about the operation thereof will be omitted. However, the CPU 21 of the first modification device performs a routine shown in a flowchart in FIG. 7 instead of the routine shown in the flowchart in FIG. 5. Steps in FIG. 7 in which the same processes as in steps shown in FIG. 5 are performed are given the same reference numerals as in FIG. 5 and detailed description thereof will be omitted.

Therefore, when a predetermined timing is reached, the CPU 21 starts a process from step 700 in FIG. 7. When the CPU 21 proceeds to step 705, the CPU 21 determines whether the stored amount VOL is larger than the first threshold amount VOL1th or not.

In a case where the stored amount VOL is larger than the first threshold amount VOL1th, the result of the determination performed by the CPU 21 in step 705 becomes “Yes” and the CPU 21 proceeds to step 710. In step 710, the CPU 21 sets both of a front side prohibition flag Xkinshi_FR to “0” and a rear side prohibition flag Xkinshi_RR to “0” and proceeds to step 795 such that the present routine is temporarily terminated.

The value of the front side prohibition flag Xkinshi_FR is set to “0” in a case where the stored amount VOL is larger than the second threshold amount VOL2th. In a case where the value of the front side prohibition flag Xkinshi_FR is “0”, the front side automatic washing is allowed. On the contrary, the value of the front side prohibition flag Xkinshi_FR is set to “1” in a case where the stored amount VOL is equal to or smaller than the second threshold amount VOL2th. In a case where the value of the front side prohibition flag Xkinshi_FR is “1”, the front side automatic washing is prohibited. Note that, the value of the front side prohibition flag Xkinshi_FR is set to “0” at the above-described initial routine.

Furthermore, the value of the rear side prohibition flag Xkinshi_RR is set to “0” in a case where the stored amount VOL is larger than the first threshold amount VOL1th. In a case where the value of the rear side prohibition flag Xkinshi_RR is “0”, the rear side automatic washing is allowed. On the contrary, the value of the rear side prohibition flag Xkinshi_RR is set to “1” in a case where the stored amount VOL is equal to or smaller than the first threshold amount VOL1th. In a case where the value of the rear side prohibition flag Xkinshi_RR is “1”, the rear side automatic washing is prohibited. Note that, the value of the rear side prohibition flag Xkinshi_RR is set to “0” at the above-described initial routine.

Meanwhile, in a case where the stored amount VOL is equal to or smaller than the first threshold amount VOL1th at a time at which the CPU 21 proceeds to step 705, the result of the determination performed by the CPU 21 in step 705 becomes “No” and the CPU 21 proceeds to step 715. In step 715, the CPU 21 determines whether the stored amount VOL is larger than “the second threshold amount VOL2th smaller than the first threshold amount VOL1th” or not.

In a case where the stored amount VOL is larger than the second threshold amount VOL2th, the result of the determination performed by the CPU 21 in step 715 becomes “Yes” and the CPU 21 proceeds to step 720. In step 720, the CPU 21 sets the value of the front side prohibition flag Xkinshi_FR to “0” and sets the value of the rear side prohibition flag Xkinshi_RR to “1”. Thereafter, the CPU 21 proceeds to step 795 such that the present routine is temporarily terminated.

Meanwhile, in a case where the stored amount VOL is equal to or smaller than the second threshold amount VOL2th at a time at which the CPU 21 proceeds to step 715, the result of the determination performed by the CPU 21 in step 715 becomes “No” and the CPU 21 proceeds to step 725.

In step 725, the CPU 21 sets both of the value of the front side prohibition flag Xkinshi_FR and the value of the rear side prohibition flag Xkinshi_RR to “1” and proceeds to step 795 such that the present routine is temporarily terminated.

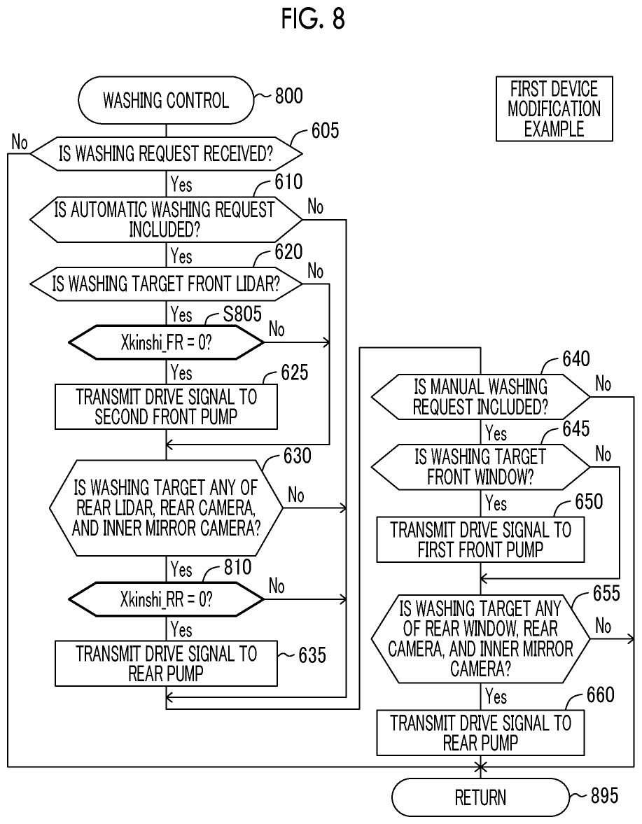

Furthermore, the CPU 21 of the first modification device performs a routine shown in a flowchart in FIG. 8 instead of the routine shown in the flowchart in FIG. 6. Steps in FIG. 8 in which the same processes as in steps shown in FIG. 6 are performed are given the same reference numerals as in FIG. 6 and detailed description thereof will be omitted.

Therefore, when a predetermined timing is reached, the CPU 21 starts a process from step 800 in FIG. 8 and proceeds to step 605 shown in FIG. 8. Here, it will be assumed that the CPU 21 has received an automatic washing request of which the washing target is the front lidar window portion 122F and an automatic washing request of which the washing target is at least one of the rear lidar window portion 122R, the rear camera window portion 142R, and the inner mirror camera window portion 142I. In this case, the result of the determination performed by the CPU 21 in step 605 shown in FIG. 8 becomes “Yes”, the result of the determination performed by the CPU 21 in step 610 shown in FIG. 8 becomes “Yes”, and the CPU 21 proceeds to step 620 shown in FIG. 8. Then, the result of the determination performed by the CPU 21 in step 620 becomes “Yes” and the CPU 21 proceeds to step 805.

In step 805, the CPU 21 determines whether the value of the front side prohibition flag Xkinshi_FR is “0” or not. In a case where the value of the front side prohibition flag Xkinshi_FR is “0”, the front side automatic washing is allowed. In this case, the result of the determination performed by the CPU 21 in step 805 becomes “Yes” and the CPU 21 proceeds to step 625 shown in FIG. 8. Accordingly, the second front pump 26Fb is driven and thus the front lidar window portion 122F is washed.

According to the assumption described above, the washing targets designated by means of the received automatic washing request include at least one of the rear lidar window portion 122R, the rear camera window portion 142R, and the inner mirror camera window portion 142I. Therefore, the result of the determination performed by the CPU 21 in step 630 becomes “Yes” and the CPU 21 proceeds to step 810.

In step 810, the CPU 21 determines whether the value of the rear side prohibition flag Xkinshi_RR is “0” or not. In a case where the value of the rear side prohibition flag Xkinshi_RR is “0”, the rear side automatic washing is allowed. In this case, the result of the determination performed by the CPU 21 in step 810 becomes “Yes” and the CPU 21 proceeds to step 635 shown in FIG. 8. Accordingly, the rear pump 26R is driven and thus all of the rear window 70, the rear lidar window portion 122R, the rear camera window portion 142R, and the inner mirror camera window portion 142I are washed at once.

Thereafter, the CPU 21 proceeds to step 640 shown in FIG. 8. Processes in step 640 to step 660 in FIG. 8 are the same as processes in step 640 to step 660 in FIG. 6. Therefore, manual washing is performed in accordance with a manual washing request.

Meanwhile, in a case where the value of the front side prohibition flag Xkinshi_FR is “1” at a time at which the CPU 21 proceeds to step 805, the front side automatic washing is prohibited. In this case, the result of the determination performed by the CPU 21 in step 805 becomes “No” and the CPU 21 proceeds to step 630 shown in FIG. 8 directly without performing step 625 shown in FIG. 8. As a result, no drive signal is transmitted to the second front pump 26Fb and thus the front side automatic washing is prohibited.

Furthermore, in a case where the value of the rear side prohibition flag Xkinshi_RR is “1” at a time at which the CPU 21 proceeds to step 810, the rear side automatic washing is prohibited. In this case, the result of the determination performed by the CPU 21 in step 810 becomes “No” and the CPU 21 proceeds to step 640 shown in FIG. 8 directly without performing step 635 shown in FIG. 8. As a result, no drive signal is transmitted to the rear pump 26R and thus the rear side automatic washing is prohibited.

As described above, in the case of the first modification device, the rear side automatic washing is prohibited without prohibition of the front side automatic washing when the stored amount VOL is decreased to become equal to or smaller than the first threshold amount VOL1th. Thereafter, both of the rear side automatic washing and the front side automatic washing are prohibited when the stored amount VOL is further decreased to become equal to or smaller than the second threshold amount VOL2th. Therefore, the first modification device can lengthen a period where “driving assistance control with use of object information from the front lidar 12F” can be performed while decreasing the speed of a decrease in washing liquid amount.

### Second Embodiment

A washing control device (hereinafter, will be referred to as “second device”) according to a second embodiment of the disclosure is different from the first device in two points as follows.

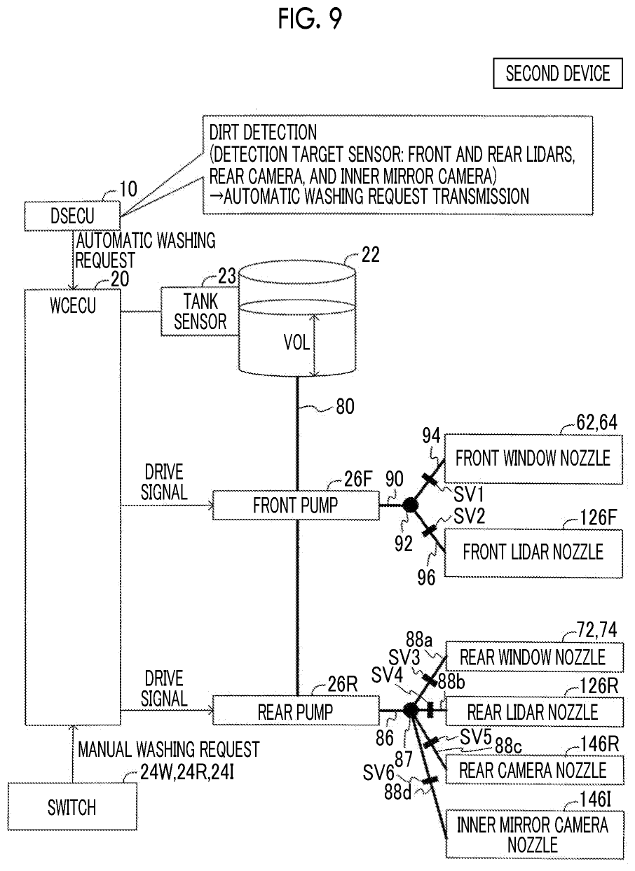

The second device includes one front pump 26F (refer to FIG. 9) instead of the first front pump 26Fa and the second front pump 26Fb.

The second device includes switching valves SV1 to SV6 (refer to FIG. 9) respectively provided in flow paths connected to nozzles and the switching valves SV1 to SV6 are opened or closed depending on the situation.

The switching valves SV1 to SV6 are valves (electromagnetic on-off valves) that open or close flow paths corresponding thereto in accordance with an instruction from the WCECU 20. Hereinafter, description will be made focusing on the above-described differences.

As shown in FIG. 9, an inflow port of the front pump 26F is connected to the tank 22 via the supply path 80. Furthermore, a discharge port of the front pump 26F is connected to a flow path 90. The flow path 90 branches into two flow paths 94, 96 at a junction portion 92. The flow path 94 is connected to the front window nozzles 62, 64. The flow path 96 is connected to the front lidar nozzle 126F.

The switching valve SV1 is provided in the flow path 94 and opens or closes the flow path 94. Therefore, in a case where the front pump 26F is driven with the flow path 94 opened by the switching valve SV1, washing liquid is ejected from the front window nozzles 62, 64 and in a case where the front pump 26F is driven with the flow path 94 closed by the switching valve SV1, no washing liquid is ejected from the front window nozzles 62, 64.

The switching valve SV2 is provided in the flow path 96 and opens or closes the flow path 96. Therefore, in a case where the front pump 26F is driven with the flow path 96 opened by the switching valve SV2, washing liquid is ejected from the front lidar nozzle 126F and in a case where the front pump 26F is driven with the flow path 96 closed by the switching valve SV2, no washing liquid is ejected from the front lidar nozzle 126F.

Similarly, the switching valves SV3 to SV6 are respectively provided in the flow paths 88a to 88d and open or close the flow paths corresponding thereto. Therefore, in a case where the rear pump 26R is driven, washing liquid is ejected from a nozzle connected to a valve out of the switching valves SV3 to SV6 that has opened a flow path corresponding thereto.

Each of the switching valves SV1 to SV6 is connected to the WCECU 20 via a connection line (not shown). Each of the switching valves SV1 to SV6 opens a flow path corresponding thereto in a case where an opening signal is received and closes the flow path corresponding thereto in a case where a closing signal is received.

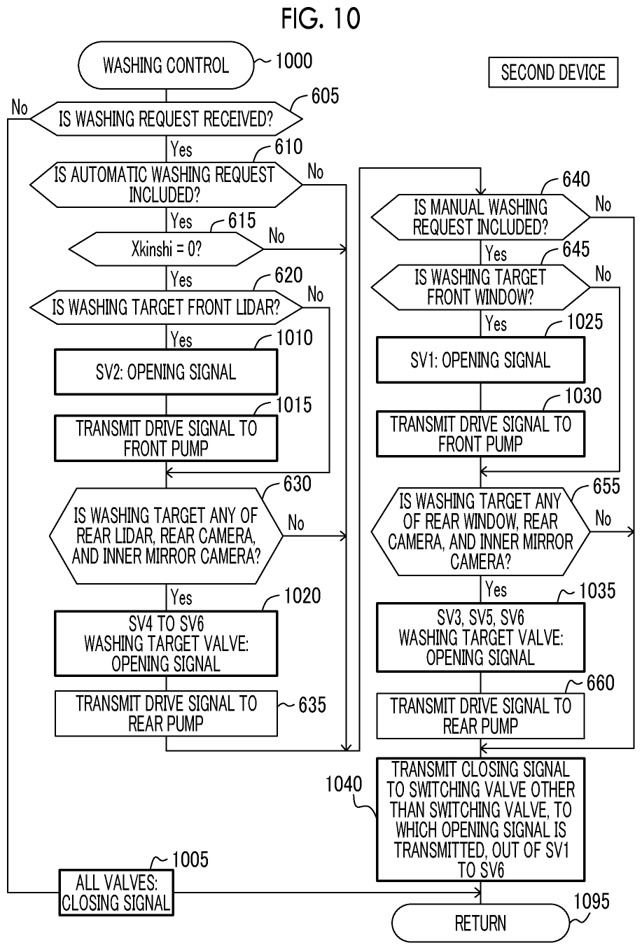

As with the CPU 11 of the first device, the CPU 11 of the second device performs the routine shown in FIG. 4. Furthermore, the CPU 21 of the second device performs the routine shown in FIG. 5 and performs a routine shown in a flowchart in FIG. 10 instead of the routine shown in the flowchart in FIG. 6. Therefore, hereinafter, the routine shown in FIG. 10 will be described. Steps in FIG. 10 in which the same processes as in steps shown in FIG. 6 are performed are given the same reference numerals as in FIG. 6 and detailed description thereof will be omitted.

When a predetermined timing is reached, the CPU 21 starts a process from step 1000 in FIG. 10 and proceeds to step 605 shown in FIG. 10. In a case where any of an automatic washing request and a manual washing request is not received by the CPU 21, the result of the determination performed by the CPU 21 in step 605 becomes “No” and the CPU 21 proceeds to step 1005.

In step 1005, the CPU 21 transmits closing signals to all of the switching valves SV1 to SV6 such that all of the switching valves SV1 to SV6 close the flow paths in which the switching valves SV1 to SV6 are respectively provided. Thereafter, the CPU 21 proceeds to step 1095 such that the present routine is temporarily terminated.

On the contrary, in a case where the CPU 21 receives washing requests including at least an automatic washing request, the result of the determination performed by the CPU 21 becomes “Yes” in all of “step 605 and step 610” shown in FIG. 10 and the CPU 21 proceeds to step 615.

In a case where the prohibition flag Xkinshi is “0”, the result of determination performed by the CPU 21 in step 615 shown in FIG. 10 becomes “Yes” and the CPU 21 proceeds to step 620. Then, in a case where washing targets designated by means of the received automatic washing request include the front lidar window portion 122F, the result of the determination performed by the CPU 21 in step 620 becomes “Yes” and the CPU 21 proceeds to step 630 shown in FIG. 10 after performing step 1010 and step 1015 in this order.

Step 1010: The CPU 21 transmits an opening signal to the switching valve SV2. As a result, the switching valve SV2 opens the flow path 96.

Step 1015: The CPU 21 transmits a drive signal to the front pump 26F.

As a result, the front pump 26F is driven with the flow path 96 opened and thus washing liquid is ejected from the front lidar nozzle 126F. At this time, no washing liquid is ejected from the front window nozzles 62, 64 in a case where a closing signal is transmitted to the switching valve SV1. In this case, it is possible to wash the front lidar window portion 122F solely by driving the front pump 26F.

Furthermore, in a case where the washing targets designated by means of the received automatic washing request include at least one of the rear lidar window portion 122R, the rear camera window portion 142R, and the inner mirror camera window portion 142I, the result of determination performed by the CPU 21 in step 630 shown in FIG. 10 becomes “Yes” and the CPU 21 proceeds to step 1020. In step 1020, the CPU 21 transmits an opening signal to a switching valve (hereinafter, will be referred to as “washing target switching valve”) out of the switching valves SV4 to SV6 that corresponds to a washing target. That is, in a case where the washing target is the rear lidar window portion 122R, the CPU 21 transmits an opening signal to the switching valve SV4. In a case where the washing target is the rear camera window portion 142R, the CPU 21 transmits an opening signal to the switching valve SV5. In a case where the washing target is the inner mirror camera window portion 142I, the CPU 21 transmits an opening signal to the switching valve SV6.

In this manner, a flow path out of the flow paths 88b to 88d that is connected to a nozzle corresponding to the washing target is opened. Next, the CPU 21 transmits a drive signal to the rear pump 26R in step 635.

As a result, washing liquid is ejected from the nozzle corresponding to the washing target. At this time, no washing liquid is ejected from the rear window nozzles 72, 74 in a case where a closing signal is transmitted to the switching valve SV3. Furthermore, in a case where a closing signal is transmitted to a switching valve out of the switching valves SV4 to SV6 that is not a washing target switching valve, no washing liquid is ejected from a nozzle connected to the switching valve. In this case, it is possible to wash a washing target window portion solely by driving the rear pump 26R.

Thereafter, the CPU 21 proceeds to step 640 shown in FIG. 10. Furthermore, in a case where the received washing requests include a manual washing request, the result of the determination performed by the CPU 21 in step 640 becomes “Yes” and the CPU 21 proceeds to step 645 shown in FIG. 10.

In a case where the washing targets designated by means of the received manual washing request include the front window 60, the result of the determination performed by the CPU 21 in step 645 becomes “Yes” and the CPU 21 proceeds to step 655 shown in FIG. 10 after performing step 1025 and step 1030 in this order.

Step 1025: The CPU 21 transmits an opening signal to the switching valve SV1. As a result, the switching valve SV1 opens the flow path 94.

Step 1030: The CPU 21 transmits a drive signal to the front pump 26F.

As a result, the front pump 26F is driven with the flow path 94 opened and thus washing liquid is ejected from the front window nozzles 62, 64. At this time, no washing liquid is ejected from the front lidar nozzle 126F in a case where a closing signal is transmitted to the switching valve SV2. In this case, it is possible to wash the front window 60 solely by driving the front pump 26F. In addition, washing liquid is ejected from the front lidar nozzle 126F also in a case where an opening signal is transmitted to the switching valve SV2. In this case, it is possible to wash both of the front window 60 and the front lidar window portion 122F by driving the front pump 26F.

Furthermore, in a case where the washing targets designated by means of the received manual washing request include at least one of the rear window 70, the rear camera window portion 142R, and the inner mirror camera window portion 142I, the result of the determination performed by the CPU 21 in step 655 shown in FIG. 10 becomes “Yes” and the CPU 21 proceeds to step 1035. In step 1035, the CPU 21 transmits an opening signal to “a washing target switching valve” out of the switching valves SV3, SV5, SV6. That is, in a case where the washing target is the rear window 70, the CPU 21 transmits an opening signal to the switching valve SV3. In a case where the washing target is the rear camera window portion 142R, the CPU 21 transmits an opening signal to the switching valve SV5. In a case where the washing target is the inner mirror camera window portion 142I, the CPU 21 transmits an opening signal to the switching valve SV6.

In this manner, a flow path out of the flow paths 88a, 88c, 88d that is connected to a nozzle corresponding to the washing target is opened. Next, the CPU 21 transmits a drive signal to the rear pump 26R in step 660.

As a result, washing liquid is ejected from the nozzle corresponding to the washing target. In a case where a closing signal is transmitted to any of the switching valves SV3 to SV6, no washing liquid is ejected from a nozzle connected to the switching valve, to which the closing signal is transmitted, at this time. In this case, it is possible to wash a washing target window portion solely by driving the rear pump 26R.

Next, the CPU 21 proceeds to step 1040 and transmits a closing signal to a switching valve out of the switching valves SV1 to SV6 that is not “a switching valve to which an opening signal is transmitted in processes in step 1010, step 1020, step 1030, and step 1035”. Then, the CPU 21 proceeds to step 1095 such that the present routine is temporarily terminated.

Note that, in a case where the received washing requests do not include an automatic washing request at a time at which the CPU 21 proceeds to step 610 shown in FIG. 10, the result of the determination performed by the CPU 21 in step 610 becomes “No” and the CPU 21 proceeds to step 640 shown in FIG. 10 directly.

In addition, in a case where the prohibition flag Xkinshi is “1” at a time at which the CPU 21 proceeds to step 615 shown in FIG. 10, the result of the determination performed by the CPU 21 in step 615 becomes “No” and the CPU 21 proceeds to step 640 shown in FIG. 10 directly. In this manner, the CPU 21 can prohibit the automatic washing.

In a case where the washing targets of the automatic washing request do not include the front lidar window portion 122F at a time at which the CPU 21 proceeds to step 620 shown in FIG. 10, the result of the determination performed by the CPU 21 in step 620 becomes “No” and the CPU 21 proceeds to step 630 directly.

In a case where the washing targets of the automatic washing request do not include any of the rear lidar window portion 122R, the rear camera window portion 142R, and the inner mirror camera window portion 142I at a time at which the CPU 21 proceeds to step 630 shown in FIG. 10, the result of the determination performed by the CPU 21 in step 630 becomes “No” and the CPU 21 proceeds to step 640 directly.

In a case where the received washing requests do not include a manual washing request at a time at which the CPU 21 proceeds to step 640 shown in FIG. 10, the result of the determination performed by the CPU 21 in step 640 becomes “No” and the CPU 21 proceeds to step 1040 directly.

In a case where the washing targets designated by means of the received manual washing request do not include the front window 60 at a time at which the CPU 21 proceeds to step 645 shown in FIG. 10, the result of the determination performed by the CPU 21 in step 645 becomes “No” and the CPU 21 proceeds to step 655 directly.

In a case where the washing targets of the manual washing request included in the received washing requests do not include any of the rear window 70, the rear camera window portion 142R, and the inner mirror camera window portion 142I at a time at which the CPU 21 proceeds to step 655 shown in FIG. 10, the result of the determination performed by the CPU 21 in step 655 becomes “No” and the CPU 21 proceeds to step 1040 directly.

As described above, the second device can individually open and close each flow path by means of the switching valves SV1 to SV6 provided in the flow paths respectively connected to the nozzles. Accordingly, it is possible to prevent washing liquid from being ejected to a window portion of a periphery sensor other than a washing target. Therefore, it is possible to prevent washing liquid from being wastefully consumed.

### Modification Example of Second Device

A washing control device (hereinafter, will be referred to as “second modification device”) according to a modification example of the second device is different from the second device in a point that threshold amounts for prohibition of automatic washing are set to be different for each window portion.

More specifically, in a case where the stored amount VOL is equal to or smaller than a third threshold amount VOL3th, the second modification device prohibits automatic washing with respect to the rear camera window portion 142R and prohibits automatic washing with respect to the inner mirror camera window portion 142I. In a case where the stored amount VOL is equal to or smaller than a fourth threshold amount VOL4th smaller than the third threshold amount VOL3th, the second modification device prohibits automatic washing with respect to the rear lidar window portion 122R. In a case where the stored amount VOL is equal to or smaller than a fifth threshold amount VOL5th smaller than the fourth threshold amount VOL4th, the second modification device prohibits automatic washing with respect to the front lidar window portion 122F. Accordingly, the modification device can prohibit automatic washing such that the larger a sensor is in importance in the driving assistance control, the later the automatic washing with respect to a window portion of the sensor is prohibited.

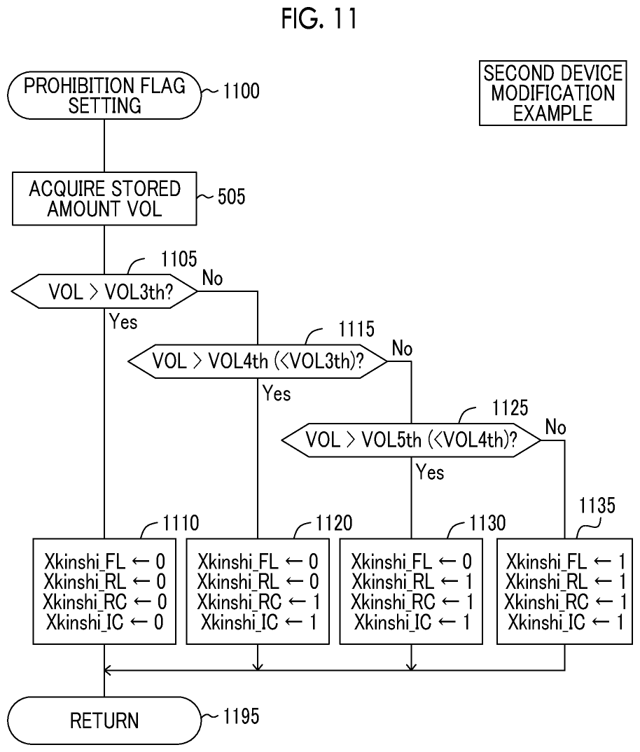

Since the CPU 11 of the second modification device performs the substantially same routine as the CPU 11 of the first device and the second device, description about the operation thereof will be omitted. However, the CPU 21 of the second modification device performs a routine shown in a flowchart in FIG. 11 instead of the routine shown in the flowchart in FIG. 5. Steps in FIG. 11 in which the same processes as in steps shown in FIG. 5 are performed are given the same reference numerals as in FIG. 5 and description thereof will be omitted.

When a predetermined timing is reached, the CPU 21 starts a process from step 1100 in FIG. 11, proceeds to step 1105, and determines whether the stored amount VOL is larger than the third threshold amount VOL3th or not.

In a case where the stored amount VOL is larger than the third threshold amount VOL3th, the result of the determination performed by the CPU 21 in step 1105 becomes “Yes” and the CPU 21 proceeds to step 1110. In step 1110, the CPU 21 sets the value of each of a front lidar prohibition flag Xkinshi_FL, a rear lidar prohibition flag Xkinshi_RL, a rear camera prohibition flag Xkinshi_RC, and an inner mirror camera prohibition flag Xkinshi_IC to “0” and proceeds to step 1195 such that the present routine is temporarily terminated.

When the value of the front lidar prohibition flag Xkinshi_FL is “1”, automatic washing with respect to the front lidar window portion 122F is prohibited and when the value of the front lidar prohibition flag Xkinshi_FL is “0”, automatic washing with respect to the front lidar window portion 122F is allowed.

When the value of the rear lidar prohibition flag Xkinshi_RL is “1”, automatic washing with respect to the rear lidar window portion 122R is prohibited and when the value of the rear lidar prohibition flag Xkinshi_RL is “0”, automatic washing with respect to the rear lidar window portion 122R is allowed.

When the value of the rear camera prohibition flag Xkinshi_RC is “1”, automatic washing with respect to the rear camera window portion 142R is prohibited and when the value of the rear camera prohibition flag Xkinshi_RC is “0”, automatic washing with respect to the rear camera window portion 142R is allowed.

When the value of the inner mirror camera prohibition flag Xkinshi_IC is “1”, automatic washing with respect to the inner mirror camera window portion 142I is prohibited and when the value of the inner mirror camera prohibition flag Xkinshi_IC is “0”, automatic washing with respect to the inner mirror camera window portion 142I is allowed.

Note that, the value of each of the prohibition flags Xkinshi_k (k=FL, RL, RC, IC) is set to “0” at the above-described initial routine.

Meanwhile, in a case where the stored amount VOL is equal to or smaller than the third threshold amount VOL3th at a time at which the CPU 21 proceeds to step 1105, the result of the determination performed by the CPU 21 in step 1105 becomes “No” and the CPU 21 proceeds to step 1115. In step 1115, the CPU 21 determines whether the stored amount VOL is larger than “the fourth threshold amount VOL4th smaller than the third threshold amount VOL3th” or not.

In a case where the stored amount VOL is larger than the fourth threshold amount VOL4th, the result of the determination performed by the CPU 21 in step 1115 becomes “Yes” and the CPU 21 proceeds to step 1120. Then, the CPU 21 sets each of the value of the front lidar prohibition flag Xkinshi_FL and the value of the rear lidar prohibition flag Xkinshi_RL to “0” and sets each of the value of the rear camera prohibition flag Xkinshi_RC and the value of the inner mirror camera prohibition flag Xkinshi_IC to “1”. Thereafter, the CPU 21 proceeds to step 1195 such that the present routine is temporarily terminated.

Meanwhile, in a case where the stored amount VOL is equal to or smaller than the fourth threshold amount VOL4th at a time at which the CPU 21 proceeds to step 1115, the result of the determination performed by the CPU 21 in step 1115 becomes “No” and the CPU 21 proceeds to step 1125. In step 1125, the CPU 21 determines whether the stored amount VOL is larger than “the fifth threshold amount VOL5th smaller than the fourth threshold amount VOL4th” or not.

In a case where the stored amount VOL is larger than the fifth threshold amount VOL5th, the result of the determination performed by the CPU 21 in step 1125 becomes “Yes” and the CPU 21 proceeds to step 1130. Then, the CPU 21 sets the value of the front lidar prohibition flag Xkinshi_FL to “0” and sets each of the value of the rear lidar prohibition flag Xkinshi_RL, the value of the rear camera prohibition flag Xkinshi_RC, and the value of the inner mirror camera prohibition flag Xkinshi_IC to “1”. Thereafter, the CPU 21 proceeds to step 1195 such that the present routine is temporarily terminated.

Meanwhile, in a case where the stored amount VOL is equal to or smaller than the fifth threshold amount VOL5th at a time at which the CPU 21 proceeds to step 1125, the result of the determination performed by the CPU 21 in step 1125 becomes “No” and the CPU 21 proceeds to step 1135. Then, the CPU 21 sets each of the values of the prohibition flags Xkinshi_FL to Xkinshi_IC to “1”. Thereafter, the CPU 21 proceeds to step 1195 such that the present routine is temporarily terminated.

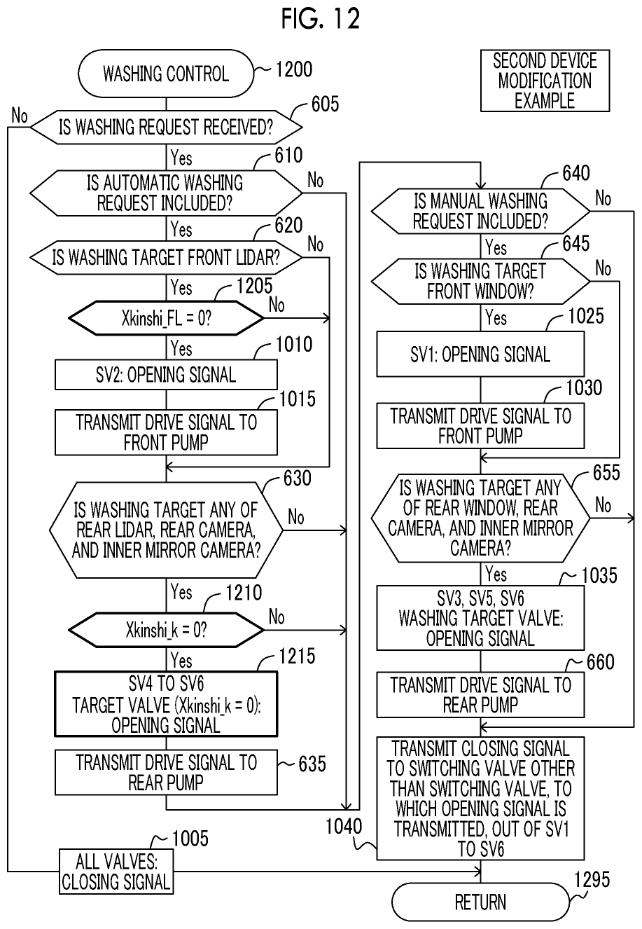

Furthermore, the CPU 21 of the second modification device performs a routine shown in a flowchart in FIG. 12 instead of the routine shown in the flowchart in FIG. 10. Steps in FIG. 12 in which the same processes as in steps shown in FIG. 10 are performed are given the same reference numerals as in FIG. 10 and detailed description thereof will be omitted.

In a case where the result of the determination performed by the CPU 21 in step 620 shown FIG. 12 is “Yes”, the CPU 21 proceeds to step 1205 and determines whether the value of the front lidar prohibition flag Xkinshi_FL is “0” or not.

In a case where the value of the front lidar prohibition flag Xkinshi_FL is not “0”, the result of the determination performed by the CPU 21 in step 1205 becomes “No” and the CPU 21 proceeds to step 630. On the contrary, in a case where the value of the front lidar prohibition flag Xkinshi_FL is “0”, the result of the determination performed by the CPU 21 in step 1205 becomes “Yes” and the CPU 21 proceeds to step 630 shown in FIG. 12 after performing processes in step 1010 and step 1015 shown in FIG. 12.

In a case where the result of the determination performed by the CPU 21 in step 630 shown FIG. 12 is “Yes”, the CPU 21 proceeds to step 1210 and determines whether prohibition flags Xkinshi_k out of the prohibition flags Xkinshi_RL, Xkinshi_RC, and Xkinshi_IC that correspond to washing targets of a received automatic washing request include a flag of which the value is “0” or not. In a case where the above-described determination condition is not satisfied, the result of the determination performed by the CPU 21 in step 1210 becomes “No” and the CPU 21 proceeds to step 640 shown FIG. 12 directly.

On the contrary, in a case where the determination condition in step 1210 is satisfied, the result of the determination performed by the CPU 21 in step 1210 becomes “Yes” and the CPU 21 proceeds to step 1215. Then, the CPU 21 transmits an opening signal to a washing target valve that corresponds to a prohibition flag out of the prohibition flags Xkinshi_RL, Xkinshi_RC, and Xkinshi_IC, of which the value is “0”. Thereafter, the CPU 11 performs step 635 shown in FIG. 12 and proceeds to step 640 shown in FIG. 12.

As described above, no opening signal is transmitted to a washing target valve corresponding to a prohibition flag Xkinshi_k of which the value is “1”. Therefore, even when a washing target designated by means of a received automatic washing request is the rear lidar window portion 122R, no valve opening signal is transmitted to the switching valve SV4 in a case where the value of the rear lidar prohibition flag Xkinshi_RL is “1”. Furthermore, even when a washing target designated by means of a received automatic washing request is the rear camera window portion 142R, no valve opening signal is transmitted to the switching valve SV5 in a case where the value of the rear camera prohibition flag Xkinshi_RC is “1”. In addition, even when a washing target designated by means of a received automatic washing request is the inner mirror camera window portion 142I, no valve opening signal is transmitted to the switching valve SV6 in a case where the value of the inner mirror camera prohibition flag Xkinshi_IC is “1”.

As described above, the second modification device can set a threshold amount for determination on whether to prohibit automatic washing or not depending on a washing target. Furthermore, in the present modification example, the fifth threshold amount VOL5th is set to the smallest value, the fourth threshold amount VOL4th is set to the second smallest value, and the third threshold amount VOL3th is set to the largest value. Therefore, it is possible to make the timing of prohibition of automatic washing corresponding to a periphery sensor, of which the importance in the driving assistance control performed by the DSECU 10 is high, late.

The disclosure is not limited to the above-described embodiments and various modification examples of the disclosure can be adopted.

The first device may not be provided with the rear camera washing switch 24R and the inner mirror camera washing switch 24I. In the first device, all of the rear window 70, the rear lidar window portion 122R, the rear camera window portion 142R, and the inner mirror camera window portion 142I are washed at once when the rear pump 26R is driven. Therefore, it is sufficient for the driver to operate the window washing switch 24W toward the driver side and a side opposite to the driver side in a case where the driver desires washing of any of the rear camera window portion 142R and the inner mirror camera window portion 142I.

Furthermore, each of the switching valves SV1 to SV6 is configured to close a flow path corresponding thereto when a closing signal is received. However, a valve that automatically closes a flow path corresponding thereto in a case where no opening signal is received may also be adopted. That is, the switching valves may be “normally closed valves”. In this case, the processes in step 1005 and step 1040 are omitted.

Furthermore, in the second device, the switching valves are respectively provided in the flow paths connected to the nozzles. However, a valve that opens one of the four flow paths 88a to 88d solely and closes the other of the four flow paths 88a to 88d may be provided at the junction portion 87 shown in FIG. 9, as a switching valve. Similarly, a valve that opens one of the two flow paths 94, 96 solely and closes the other of the two flow paths 94, 96 may be provided at the junction portion 92 shown in FIG. 9, as a switching valve.

Furthermore, a periphery sensor to which washing liquid is to be ejected is not limited to a lidar, a camera, and the like and may be any remote sensing sensor (for example, sonar or far-infrared camera) that acquires information about an object positioned in the vicinity of a vehicle by receiving an electromagnetic wave including light or an acoustic wave through a window portion.

What is claimed is:

1. A vehicle comprising:
a tank configured to store washing liquid;
a washing device configured to wash a first washing target portion and a second washing target portion by using the stored washing liquid; and
a control device configured to perform manual washing in which the washing device is caused to wash at least the first washing target portion when a washing request is made by an occupant of the vehicle, determine whether the second washing target portion is dirty or not, and perform automatic washing in which the washing device is caused to wash at least the second washing target portion when a determination is made that the second washing target portion is dirty,
wherein the control device is configured not to perform the automatic washing even when a determination is made that the second washing target portion is dirty in a case where a stored amount, which is an amount of the washing liquid stored in the tank, is equal to or smaller than a predetermined threshold amount.

2. The vehicle according to claim 1, further comprising an information acquisition device configured to receive an electromagnetic wave or an acoustic wave passing through a window portion and acquire information about an object positioned in a vicinity of the vehicle based on the received electromagnetic wave or the received acoustic wave, wherein:
the first washing target portion is a front window of the vehicle; and
the second washing target portion is the window portion.

3. The vehicle according to claim 2, wherein the control device is configured to determine whether the second washing target portion is dirty or not based on the information about the object acquired by the information acquisition device.

4. The vehicle according to claim 2, wherein:
a first sensor that receives an electromagnetic wave or an acoustic wave passing through a first window portion is provided as the information acquisition device;
a second sensor that receives an electromagnetic wave or an acoustic wave passing through a second window portion is provided; and
the control device is configured to
perform the automatic washing in which the washing device is caused to wash at least the first window portion as first automatic washing when a determination is made that the first window portion as the second washing target portion is dirty,
determine whether the second window portion is dirty or not,
perform second automatic washing in which the washing device is caused to wash at least the second window portion when a determination is made that the second window portion is dirty,
perform no first automatic washing even when a determination is made that the first window portion is dirty and perform the second automatic washing when a determination is made that the second window portion is dirty in a case where the stored amount is equal to or smaller than a first threshold amount, which is the threshold amount, and is larger than a second threshold amount smaller than the first threshold amount, and
perform no first automatic washing even when a determination is made that the first window portion is dirty and perform no second automatic washing even when a determination is made that the second window portion is dirty in a case where the stored amount is equal to or smaller than the second threshold amount.

5. The vehicle according to claim 4, wherein:
the first sensor is a rear periphery sensor that receives an electromagnetic wave reflected by an object positioned in a region behind the vehicle through the first window portion; and
the second sensor is a front periphery sensor that receives an electromagnetic wave reflected by an object positioned in a region ahead of the vehicle through the second window portion.
